(19) United States
(12) Patent Application Publication
(10) Pub. No.: US 2007/0189469 A1
(43) Pub. Date: Aug. 16, 2007

(54) Method and apparatus for providing location information for an emergency service

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/344,643

(22) Filed: Jan. 31, 2006

(51) Int. Cl. H04M 11/04

(52) U.S. Cl. 379/45; 379/37

(57) ABSTRACT

A method and apparatus for providing an update reminder with an embedded hotlink to a subscriber to update their actual physical location information each time a change in actual physical location is detected by the network are disclosed. For example, subscribers must either enter their new physical location address information or willingly decline to provide such information before a phone call can be placed from their software based client device.

The present invention relates generally to communication networks and, more particularly, to a method and apparatus for providing location information for emergency service via software based clients in communication networks, e.g. packet networks such as Voice over Internet Protocol (VoIP) networks.

### BACKGROUND OF THE INVENTION

Providers of VoIP network services often support multiple types of access devices that interface into the edge network element of the VoIP network. VoIP providers are beginning to offer software based clients to subscribers that use personal laptops and mobile devices equipped with a piece of special VoIP client software application to enable VoIP telephony mobility and access without the need of hardware endpoint device. These network service providers also are required to provide Enhance 911 (E911) call services that are equivalent to the one supported by traditional wire line telephones. Supporting E911 services to a VoIP subscriber who remains stationary is rather straightforward; however, mobile subscribers who use software based client on their personal laptops for VoIP phone services pose a serious problem for network service providers to support E911 services for these mobile subscribers.

Therefore, a need exists for a method and apparatus for providing location information for emergency service via software based clients in a packet network, e.g., a VoIP network.

### SUMMARY OF THE INVENTION

In one embodiment, the present invention provides a method to send an update reminder with an embedded hotlink to a subscriber to update their actual physical location information each time a change in actual physical location is detected by the network. For example, subscribers must either enter their new physical location address information or willingly decline to provide such information before a phone call can be placed from their software based client device.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of providing location information for emergency service via software based clients in a VoIP network of the present invention;

FIG. 3 illustrates a flowchart of a method for providing location information for emergency service via software based clients in a packet network, e.g., a VoIP network, of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

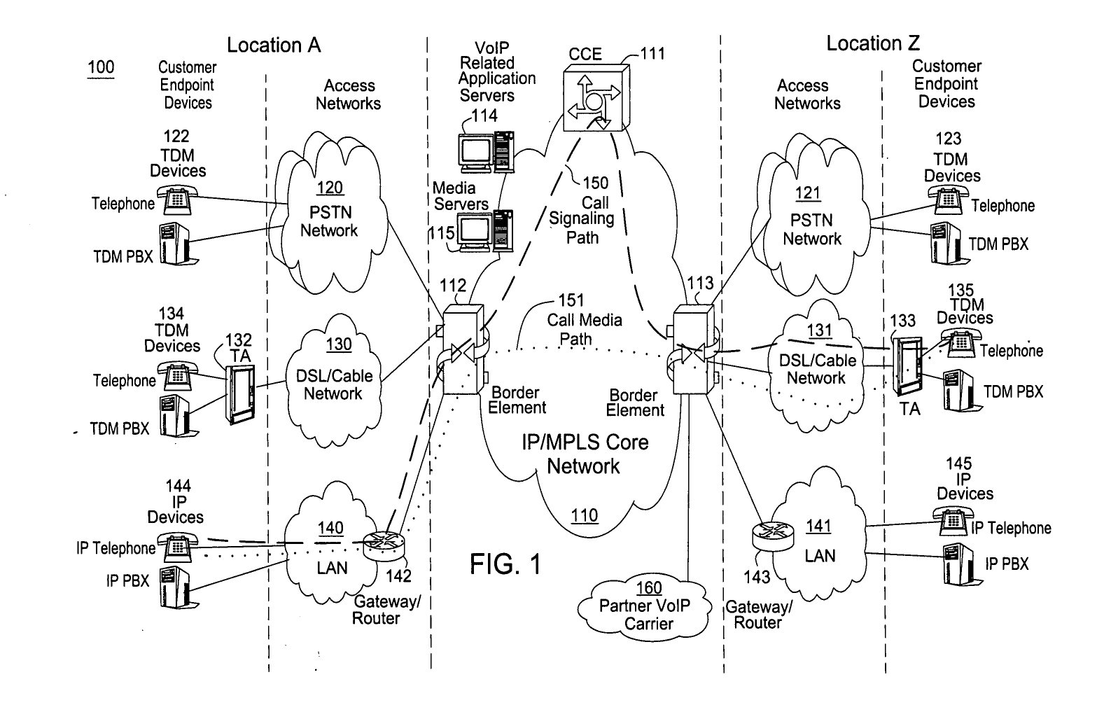

To better understand the present invention, FIG. 1 illustrates a communication architecture 100 having an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a SIP back-to-back user agent. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP 200 OK response message if SIP is used, is sent in the reverse direction back to the CCE 111. After the CCE 111 receives the call acknowledgement message, it will then send a call acknowledgement signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup up between two endpoints, the CCE 111 does not need to be in the data path for actual direct data exchange.

Media Servers (MS) 115 are special servers that typically handle and terminate media streams, and to provide services such as announcements, teleconference bridges, transcoding, and Interactive Voice Response (IVR) messages for VoIP service applications.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Providers of VoIP network services often support multiple types of access devices that interface into the edge network element of the VoIP network. VoIP providers are beginning to offer software based clients to subscribers that use personal laptops and mobile devices equipped with a piece of special VoIP client software application to enable VoIP telephony mobility and access without the need of hardware endpoint device. These network service providers also are required to provide Enhance 911 (E911) call services that are equivalent to the one supported by traditional wire line telephones. Supporting E911 services to a VoIP subscriber who remains stationary is rather straightforward; however, mobile subscribers who use software based client on their personal laptops for VoIP phone services pose a serious problem for network service providers to support E911 services for these mobile subscribers.

To address this need, the present invention provides a method to send an update reminder with an embedded hotlink to a subscriber to update their actual physical location information each time a change in actual physical location is detected by the network. For example, subscribers must either enter their new physical location address information or willingly decline to provide such information before a phone call can be placed from their software based client device.

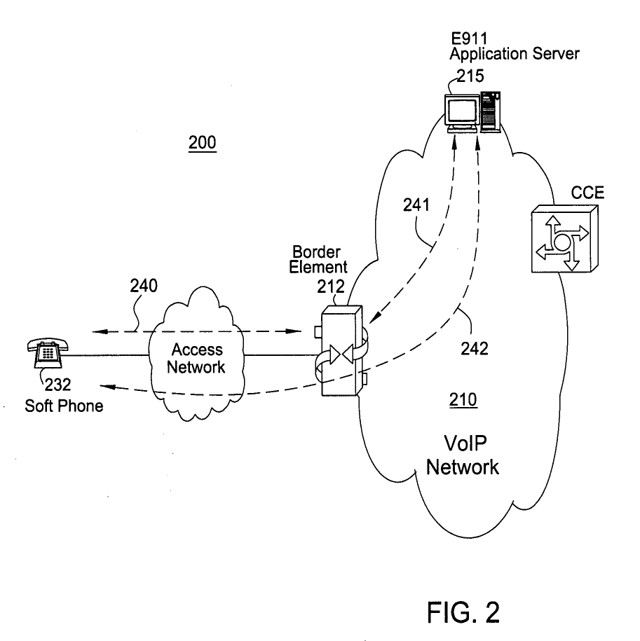

FIG. 2 illustrates an example 200 of providing location information for emergency service via software based clients in a packet network, e.g., a VoIP network of the present invention. In FIG. 2, a subscriber uses Soft Phone 232 to access VoIP network services. For example, a soft phone is a VoIP endpoint device that runs a software based client that allow subscribers to place and receive VoIP phone calls via a laptop computer or a wireless device without a hardware endpoint device, such as a TA. When Soft Phone 232 registers with VoIP network 210, Soft Phone 232 sends a set of information including, but not limited to, an IP address, a Media Access Control (MAC) address, and the phone number associated with Soft Phone 232 to BE 212 using flow 240. Soft Phone 232 needs to register with VoIP network 210 typically after software or hardware resident in Soft Phone 232 has been reset or Soft Phone 232 has previously lost connectivity to VoIP network 210. Upon receiving the registration information from Soft Phone 232, BE 212 forwards the received information to E911 Application Server 215 using flow 241 for processing. Based on the information received, E911 AS 215 determines if a physical location change of Soft Phone 232 is detected. In one embodiment, a physical location changed is assumed when the current IP address associated with Soft Phone 232 is different from the IP address obtained from the last registration. If a physical location change is detected, E911 AS 215 sends a request to Soft Phone 232 using flow 242 to request the subscriber to update the physical location address information of Soft Phone 232. The subscriber can update the latest physical location address information, voluntarily decline to provide the address update, or refuse to accept either of the provided options. In one embodiment, if the subscriber chooses to update the address information or decline voluntarily to provide address update, E911 AS 215 will signal BE 212 using flow 241 to allow Soft Phone 232 to gain access to VoIP network 210. In one embodiment, if the subscriber refuses to accept either of the provided options, E911 AS will signal BE 212 using flow 241 to block Soft Phone 232 to gain access to VoIP network 210. If a physical location change is not detected, E911 AS 215 will signal BE 212 to allow Soft Phone 232 to gain access to VoIP network 210 by default.

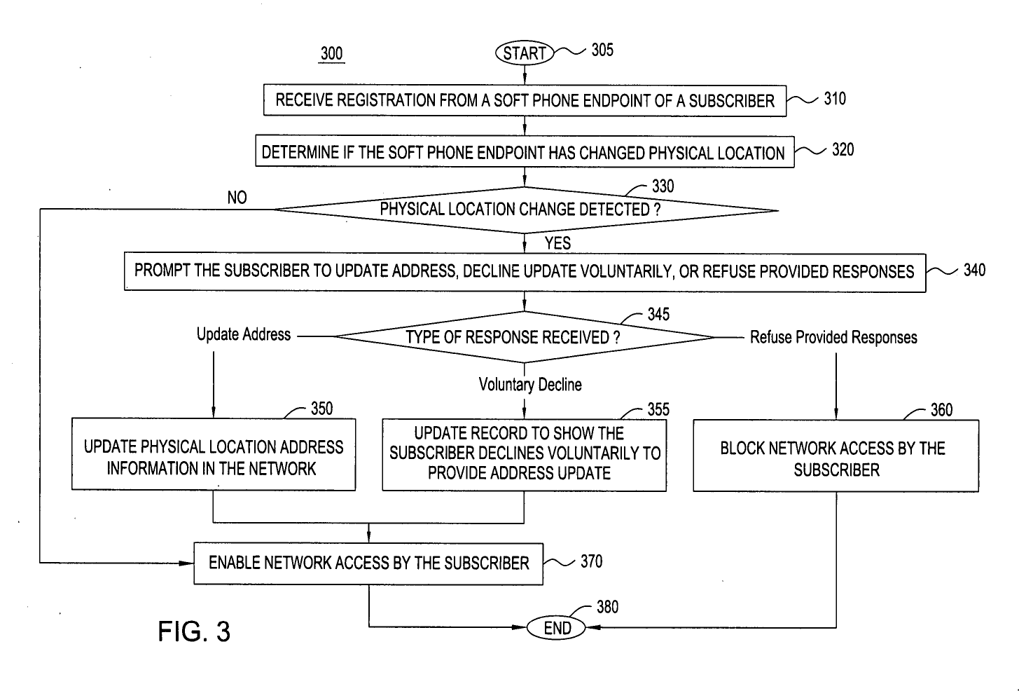

FIG. 3 illustrates a flowchart of a method 300 for providing location information for emergency service via software based clients in a packet network, e.g., a VoIP network, of the present invention. Method 300 starts in step 305 and proceeds to step 310.

In step 310, the method receives a registration from a soft phone endpoint of a subscriber. For example, the soft phone sends a set of information including, but not limited to, the IP address, the Media Access Control (MAC) address, and the phone number associated with the soft phone to the network as part of the registration. In one embodiment, the soft phone needs to register with the VoIP network typically after software or hardware resident in the soft phone has been reset or the soft phone has previously lost connectivity to the VoIP network. The registration is received by a BE at the edge of the VoIP network and forwarded to an E911 AS for processing by the BE.

In step 320, the method determines if a physical location change of the soft phone has occurred. The occurrence of a physical location change is determined by the E911 AS. In one embodiment, a physical location change is assumed when the current IP address associated with the soft phone is different from the IP address obtained from the last registration.

In step 330, the method checks if a physical location change is detected. If a physical location change is detected, the method proceeds to step 340; otherwise, the method proceeds to step 370.

In step 340, the method sends a set of available options to the subscriber e.g., via a pop up window, to the soft phone to choose from. The subscriber can choose to update the latest physical address information, decline voluntarily to update the address information, or refuse to accept either of the two provided options.

In step 345, the method checks the type of response received from the subscriber. The response is received by the E911 AS from the soft phone. If the response type is to update address information, the method proceeds to step 350. If the response type is to decline voluntarily to update address information, the method proceeds to step 355. If the response type is to refuse the two provided options, the method proceeds to step 360.

In step 350, the method updates the latest physical address information of the subscriber in the network. For example, the latest physical address information is updated and stored by the E911 AS.

In step 355, the method updates a record in the network indicating that the subscriber has declined voluntarily to provide an address change update. For example, the record is updated and stored by the E911 AS.

In step 360, the method blocks network access by the subscriber.

In step 370, the method enables network access by the subscriber. The method ends in step 380.

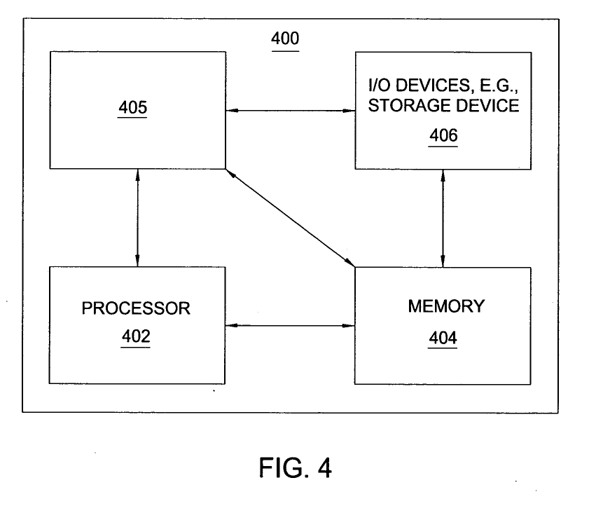

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing location information for emergency service via software based clients, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing location information for emergency service via software based clients can be loaded into memory 404 and executed by processor 402 to implement the functions as discussed above. As such, the present process 405 for providing location information for emergency service via software based clients (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing location information for an emergency service in a communication network, comprising:
receiving a registration from a soft phone client used by a subscriber;
determining if a change of physical location of said soft phone client is detected; and
presenting a prompt to said subscriber for updating said physical location of said soft phone client if said change of said physical location of said soft phone client is detected.

2. The method of claim 1, wherein said communication network is a Voice over Internet Protocol (VoIP) network or a Service over Internet Protocol (SoIP) network.

3. The method of claim 1, wherein said emergency service is an Enhanced 911 (E911) service.

4. The method of claim 1, wherein said registration comprises at least one of: an Internet Protocol (IP) address, a Media Access Control (MAC) address, or a phone number associated with said soft phone client.

5. The method of claim 1, wherein said change of physical location is determined by an E911 Application Server.

6. The method of claim 1, further comprising:
enabling said soft phone client to gain service access to said communication network only after said subscriber provides a predefined response to said prompt.

7. The method of claim 6, wherein said presenting comprises:
presenting said prompt that allows said subscriber to update a physical address, to decline voluntarily to update said physical address or to refuse to provide a response.

8. The method of claim 7, wherein said enabling comprises:
allowing said soft phone client to gain service access to said communication network if said predefined response is to update said physical address or to decline voluntarily to update said physical address; and
blocking said soft phone client to gain service access to said communication network if said subscriber has chosen to refuse to provide said response.

9. The method of claim 1, wherein said prompt is a pop up window.

10. The method of claim 6, wherein said soft phone client is enabled to gain service access to said communication network via an E911 Application Server.

11. A computer-readable medium having stored thereon a plurality of instructions, the plurality of instructions including instructions which, when executed by a processor, cause the processor to perform the steps of a method for providing location information for an emergency service in a communication network, comprising:
receiving a registration from a soft phone client used by a subscriber;
determining if a change of physical location of said soft phone client is detected; and
presenting a prompt to said subscriber for updating said physical location of said soft phone client if said change of said physical location of said soft phone client is detected.

12. The computer-readable medium of claim 11, wherein said communication network is a Voice over Internet Protocol (VoIP) network or a Service over Internet Protocol (SoIP) network.

13. The computer-readable medium of claim 11, wherein said emergency service is an Enhanced 911 (E911) service.

14. The computer-readable medium of claim 11, wherein said registration comprises at least one of: an Internet Protocol (IP) address, a Media Access Control (MAC) address, or a phone number associated with said soft phone client.

15. The computer-readable medium of claim 11, wherein said change of physical location is determined by an E911 Application Server.

16. The computer-readable medium of claim 11, further comprising:
enabling said soft phone client to gain service access to said communication network only after said subscriber provides a predefined response to said prompt.

17. The computer-readable medium of claim 16, wherein said presenting comprises:
presenting said prompt that allows said subscriber to update a physical address, to decline voluntarily to update said physical address or to refuse to provide a response.

18. The computer-readable medium of claim 17, wherein said enabling comprises:
allowing said soft phone client to gain service access to said communication network if said predefined response is to update said physical address or to decline voluntarily to update said physical address; and
blocking said soft phone client to gain service access to said communication network if said subscriber has chosen to refuse to provide said response.

19. The computer-readable medium of claim 11, wherein said prompt is a pop up window.

20. An apparatus for providing location information for an emergency service in a communication network, comprising:
means for receiving a registration from a soft phone client used by a subscriber;
means for determining if a change of physical location of said soft phone client is detected; and
means for presenting a prompt to said subscriber for updating said physical location of said soft phone client if said change of said physical location of said soft phone client is detected.
